(19) United States
(12) Patent Application Publication
(10) Pub. No.: US 2023/0342398 A1
(43) Pub. Date: Oct. 26, 2023

(54) USING LIGHTWEIGHT MACHINE-LEARNING MODEL ON SMART NIC

(71) Applicant: VMware, Inc., Palo Alto, CA (US)

(72) Inventors: Shay Vargaftik, Herzliya (IL); Yaniv Ben-Itzhak, Afek (IL); Alex Markuze, Ramat Gan (IL); Igor Golikov, Kfar Saba (IL); Avishay Yanai, Petach-Tikva (IL)

(21) Appl. No.: 17/727,230

(22) Filed: Apr. 22, 2022

(51) Int. Cl. G06F 16/903

(52) U.S. Cl. CPC G06F 16/90335

(57) ABSTRACT

Some embodiments provide a method for using a machine learning (ML) model to respond to a query, at a smart NIC of a computer. The method receives a query including an input. The method applies a first ML model to the input to generate an output and a confidence measure for the output. When the confidence measure for the output is below a threshold, the method discards the output and provides the query to the computer for the computer to apply a second ML model to the input.

### BACKGROUND

Especially in the datacenter context, programmable smart network interface controllers (NICs) are becoming more commonplace. These smart NICs typically include a central processing unit (CPU), possibly in addition to one or more application-specific integrated circuits (ASICs) or field-programmable gate arrays (FPGAs). These ASICs (or FPGAs) can be designed for packet processing as well as other uses. However, the inclusion of the CPU also allows for more configurability of the smart NICs, thereby enabling the offloading of some tasks from software of a host computer.

### BRIEF SUMMARY

Some embodiments provide a method for using a smart network interface controller (NIC) to execute a trained machine learning (ML) model that provides fast, high-confidence outputs. When a smart NIC at a computer receives an input for the ML model, the smart NIC applies a first trained version of the ML model to the received input in order to generate (i) an output and (ii) a confidence measure for the output. If the confidence measure is below a threshold, the smart NIC provides the input to a server that executes a second trained version of the ML model and generates an output. However, if the confidence measure is above the threshold, the smart NIC returns its output without providing the input to the server.

The first version of the ML model, in some embodiments, is a smaller, more coarse-grained version of the ML model than the second version, such that the first version can be executed by the more limited processors of the smart NIC. However, the first version of the ML model can be executed faster and return an output faster by virtue of (i) requiring less processing and (ii) being executed at the smart NIC rather than at the server. In some embodiments, the smart NIC includes application-specific integrated circuits (ASICs) designed for executing ML models and/or graphics processing units (GPUs) which are capable of quickly executing ML models.

The relation of the first version of the ML model to the second version of the ML model depends on the type of ML model, in some embodiments. For instance, for a neural network, some embodiments train two different versions of the ML model using a same dataset of training inputs. In this case, the first version of the model may have fewer layers and/or smaller layers (e.g., with fewer filters per layer and/or smaller filters). In some embodiments, the first version of the neural network is sparser than the second version (i.e., a greater percentage of the weights of the first version are set to zero than the second version) to make for simpler computations.

Many other types of ML models can also be implemented in this manner in different embodiments. For instance, a random forest (RF) model that uses numerous decision trees for tasks such as classification or regression may be used. In some embodiments, the second version of the RF model is the fully trained model (e.g., with a full set of full-depth decision trees) while the first version executed on the smart NIC is a smaller version of that trained model that uses a smaller number of decision trees or limited-depth decision trees (or both). A boosting model that includes a particular number of decision trees to perform, e.g., a classification task is another type of ML model used in some embodiments. In some such embodiments, the second version of the boosting model is the fully trained model (e.g., with Y decision trees) while the first version executed on the smart NIC is a smaller version that only uses j decision trees (where j<Y).

As noted, the first version of the ML model outputs a confidence measure in addition to the output. This confidence measure specifies a likelihood or probability that the output is correct. When the confidence measure is above a threshold (e.g., 0.9), the smart NIC returns the output without any need for processing by the larger second version of the ML model. For classification tasks (i.e., an ML model that classifies an input into one of a set of categories), as an example, the ML model of some embodiments generates a probability distribution across the categories (i.e., a probability for each category that the input belongs to that category). The output is then the category with the highest probability. However, if the first version of the ML model generates a 45% probability for one category, 30% probability for a second category, and 25% probability for a third category, then the smart NIC would pass the input to the server for processing by the fuller model (which would hopefully have a better prediction for the input). Examples of types of classification tasks include classifying images (or video) into one or more categories based on the object or objects represented in the images, classifying audio snippets by speaker, etc.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a machine-learning (ML) server with a smart NIC according to some embodiments.

FIG. 2 conceptually illustrates the use of smart NICs in an ML cluster of some embodiments with multiple ML servers that use smart NICs.

FIG. 3 conceptually illustrates the hardware of a smart NIC of some embodiments that can be configured to execute a lightweight version of an ML model.

FIG. 4 conceptually illustrates the NIC OS of a smart NIC of some embodiments.

FIG. 5 conceptually illustrates a process of some embodiments for applying an ML model to an input received at a smart NIC (e.g., the smart NIC).

FIG. 6 conceptually illustrates a full version and a lightweight version of a convolutional neural network of some embodiments.

FIG. 7 conceptually illustrates a full version and a lightweight version of a random forest (RF) model of some embodiments.

FIG. 8 conceptually illustrates a full version and a lightweight version of a boosting model of some embodiments.

FIG. 9 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for using a smart network interface controller (NIC) to execute a trained machine learning (ML) model that provides fast, high-confidence outputs. When a smart NIC at a computer receives an input for the ML model, the smart NIC applies a first trained version of the ML model to the received input in order to generate (i) an output and (ii) a confidence measure for the output. If the confidence measure is below a threshold, the smart NIC provides the input to a server that executes a second trained version of the ML model and generates an output. However, if the confidence measure is above the threshold, the smart NIC returns its output without providing the input to the server.

The first version of the ML model, in some embodiments, is a smaller, more coarse-grained version of the ML model than the second version, such that the first version can be executed by the more limited processors of the smart NIC. However, the first version of the ML model can be executed faster and return an output faster by virtue of (i) requiring less processing and (ii) being executed at the smart NIC rather than at the server. In some embodiments, the smart NIC includes application-specific integrated circuits (ASICs) designed for executing ML models and/or graphics processing units (GPUs) which are capable of quickly executing ML models.

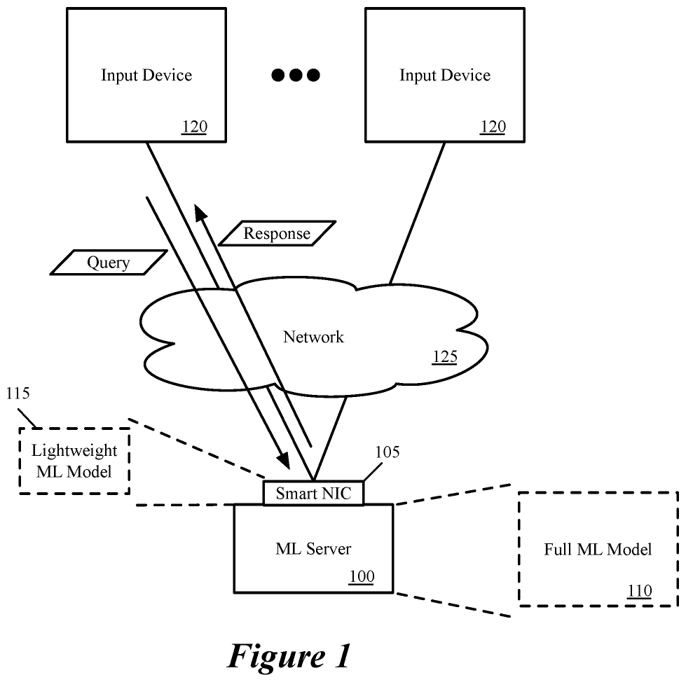

FIG. 1 conceptually illustrates a machine-learning (ML) server 100 with a smart NIC 105 according to some embodiments of the invention. The ML server 100, in some embodiments, can be a bare metal computing device, a virtual machine (VM) executing on a host computer, a container, or another data compute node (DCN). The ML server 100 executes a full ML model 110 to respond to queries from a set of input devices 120. This ML model may be a neural network, a random forest model, a boosting model, or any other type of ML model that receives inputs and generates outputs for each input. In addition, the ML model 110 may receive any sort of input/query and perform any type of task for these inputs. For instance, the ML model 110 may receive audio snippets, still images, video streams, network traffic statistics, etc. as inputs in different embodiments. The ML model 110 may categorize each input into one of a set of categories (e.g., which of a predefined set of object types is present in an image), determine whether the input matches a specific category (e.g., does the audio input match a particular person's voice), detect whether a particular event has occurred (e.g., is an anomaly identified in a network), or perform a different task.

The ML server 100 receives these queries through a network 125 from the set of input devices 120. The network 125 may be datacenter network (e.g., if the ML server 100 analyzes statistics for a datacenter, analyzes audio and/or video input from input devices connected via a local network, etc.), a virtual private network (VPN), a wide-area network (e.g., if the ML server 100 analyzes inputs for a large enterprise with input devices at various geographic areas), a public network (e.g., if the ML server 100 analyzes inputs from public clients in various geographic areas), or a combination of various types of networks.

The input devices 120, in some embodiments, are devices that include input capture devices (e.g., cameras, microphones, etc.). In other embodiments, the devices are data collection devices that collect statistics or other data and provide the collected data to the ML server 100 as an input or set of inputs. For instance, in some embodiments, a network statistics collector collects or generates network statistics and provides these statistics to the ML server 100, which analyzes the statistics to, e.g., detect network anomalies based on patterns in the network traffic. The ML server 100 provides a response back to the input device 120 that sends a query, after performing its specified task to generate the response to the query.

The smart NIC 105, as described in more detail below, is a configurable network interface controller that includes a (typically low-power) general-purpose CPU in addition to one or more purpose-specific circuits (e.g., data message processing circuits). In some embodiments, the smart NIC 105 is configured to execute a lightweight version 115 of the ML model executed by the ML server 100.

Because the smart NIC 105 includes the physical interface that receives and sends data traffic for the ML server, the smart NIC 105 receives the queries from the input devices 120 directly via the network 125. The smart NIC 105 applies the lightweight version 115 of the model to each received query in order to generate (i) an output and (ii) a confidence measure for the output. When the confidence measure is above a threshold (e.g., 90%), the smart NIC 105 does not pass the query to the ML server 100, and instead returns the output via the network 125 as a response to the requesting input device 120. On the other hand, if the confidence measure is below the threshold, the smart NIC 105 passes the query on to the ML server 100 for the ML server to apply the full version 110 of the ML model to the query. In this case, the ML server 100 returns the generated output from the full ML model 110 as a response to the requesting input device 120 via the smart NIC 105.

Implementing the lightweight version of the ML model on the smart NIC allows for many queries to be answered significantly faster. The application-specific circuits of the smart NIC can be configured to execute an ML model more quickly than the host computer processors, and processing the query on the smart NIC avoids the delay in providing the query data to the host computer memory. However, a typical smart NIC cannot execute the full version of many ML models, so the lightweight version is used. In many cases, as long as the confidence measure from the lightweight version is appropriately high, the lightweight version outputs the correct answer nearly all of the time.

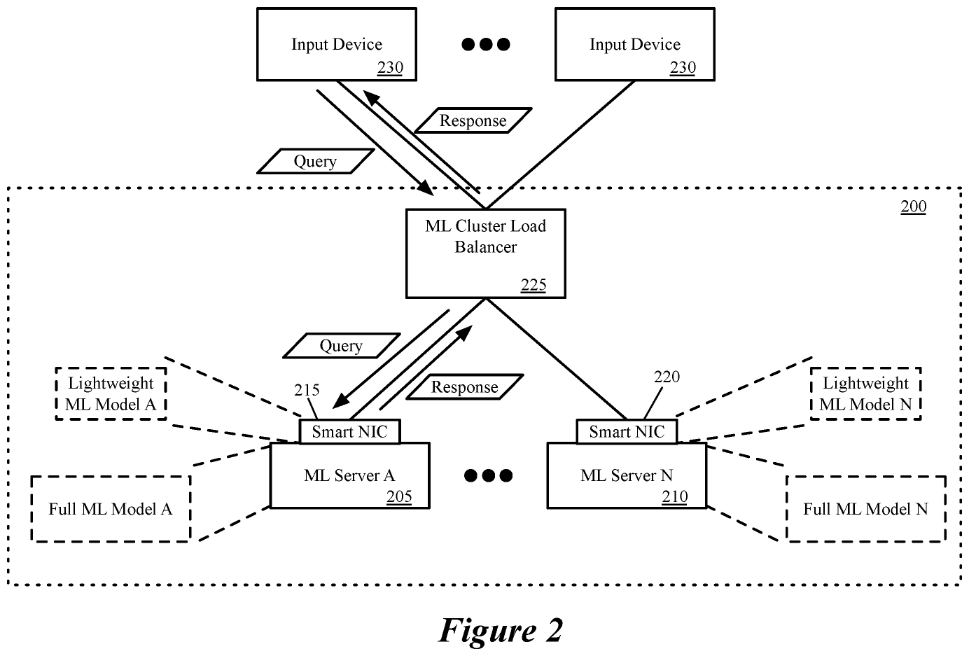

FIG. 2 conceptually illustrates the use of smart NICs in an ML cluster 200 of some embodiments with multiple ML servers 205-210 that use smart NICs 215-220 in a similar manner. In this case, the ML cluster includes a load balancer 225 that can receive multiple different types of queries for different ML models A-N from a set of input devices 230. Each ML model is implemented on one or more of the ML servers 205-210, each with an associated smart NIC 215-220. When the ML cluster load balancer 225 receives a query (through a network, not shown in the figure for simplicity), the load balancer 225 identifies the type of query and passes it to the ML server 205-210 that runs the appropriate ML model for the query (via an internal network, also not shown). At each ML server 205-210, the corresponding smart NIC 215-220 receives this query and applies the lightweight version of its ML model to the query in the manner described above. Based on the generated confidence measure, the smart NIC 215-220 either returns its output or passes the query to its ML server, which then generates an output. The output is returned to the input device 230 (e.g., through the load balancer 225 or directly to the input device).

It should be understood that different configurations are also possible in different embodiments. For instance, multiple ML servers (executing different models) could execute on the same host computer, in which case a single smart NIC of the host computer executes multiple ML models. In addition, a single query might be directed to multiple different ML models in some embodiments, with each ML model having a corresponding lightweight version implemented by a smart NIC. For instance, streaming video might be sent to one ML model to perform face detection, another to perform object recognition, etc. Similarly, network statistics could be sent to different types of anomaly detection or other analysis models. In other embodiments, the cluster includes multiple ML servers executing the same model, with the cluster load balancer balancing queries between the servers using any of various load balancing metrics (round robin, random assignment, etc.).

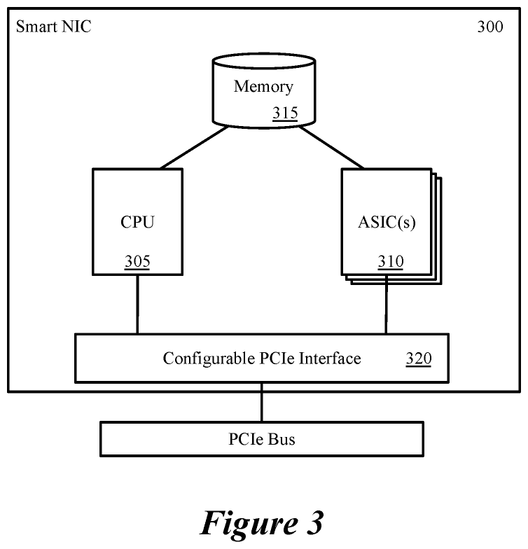

As mentioned above, the smart NICs of some embodiments include both a general-purpose processor (typically less powerful than the processor of the computer for which the smart NIC acts as the network interface) as well as one or more application-specific circuits. FIG. 3 conceptually illustrates the hardware of a smart NIC 300 of some embodiments that can be configured to execute a lightweight version of an ML model. As shown, the smart NIC 300 includes its own general-purpose (x86) CPU 305, a set of application-specific integrated circuit (ASICs) 310, memory 315, and a configurable PCIe interface 320. The ASICs 310, in some embodiments, include at least one I/O ASIC that handles the processing of packets forwarded to and from the computer, and are at least partly controlled by the CPU 305. In some embodiments, either in addition to or as an alternative to the ASICs, the smart NIC may include a set of configurable field-programmable gate arrays (FPGAs). These ASICs or FPGAs, in some embodiments, can execute the lightweight ML model in some embodiments.

The configurable PCIe interface 320 enables connection of the smart NIC 300 to the other physical components of a computer system (e.g., the x86 CPU, memory, etc.) via the PCIe bus of the computer system. Via this configurable PCIe interface, the smart NIC 300 can present itself to the computer system as a multitude of devices, including a data message processing NIC, a hard disk (using non-volatile memory express (NVMe) over PCIe), or other types of devices. The CPU 305 executes a NIC operating system (OS) in some embodiments that controls the ASICs 310 and can perform other operations, such as execution of a lightweight ML model. That is, the lightweight ML model may be executed by the CPU of the smart NIC in some embodiments and by the ASIC or FPGA of the smart NIC in other embodiments.

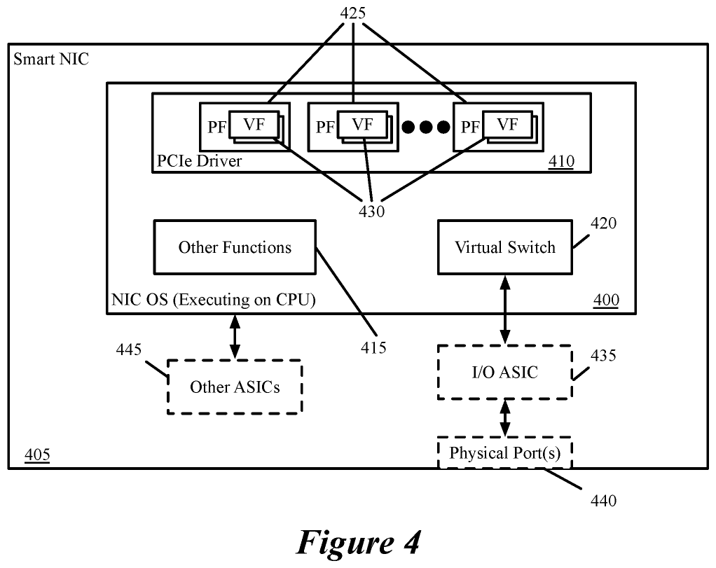

FIG. 4 conceptually illustrates the NIC OS 400 of a smart NIC 405 of some embodiments. The NIC OS 400 is executed, in some embodiments, by the CPU of the smart NIC (e.g., CPU 305). This NIC OS 400 includes a PCIe driver 410, a virtual switch 420, and other functions 415.

The PCIe driver 410 includes multiple physical functions 425, each of which is capable of instantiating multiple virtual functions 430. These different physical functions 425 enable the smart NIC to present as multiple different types of devices to the computer system to which it attaches via its PCIe bus. For instance, the smart NIC can present itself as a network adapter (for processing data messages to and from the computer system) as well as a non-volatile memory express (NVMe) disk in some embodiments.

The NIC OS 400 of some embodiments is capable of executing a virtualization program (similar to a hypervisor) that enables sharing resources (e.g., memory, CPU resources) of the smart NIC among multiple machines (e.g., VMs) if those VMs execute on the computer. The virtualization program can provide compute virtualization services and/or network virtualization services similar to a managed hypervisor in some embodiments. These network virtualization services, in some embodiments, include segregating data messages into different private (e.g., overlay) networks that are defined over the physical network (shared between the private networks), forwarding the data messages for these private networks (e.g., performing switching and/or routing operations), and/or performing middlebox services for the private networks.

To implement these network virtualization services, the NIC OS 400 of some embodiments executes the virtual switch 420. The virtual switch 420 enables the smart NIC to perform software-defined networking and provide the I/O ASIC 435 of the smart NIC 405 with a set of flow entries so that the I/O ASIC 435 can perform flow processing offload (FPO) for the computer system in some embodiments. The I/O ASIC 435, in some embodiments, receives data messages from the network and transmits data messages to the network via one or more physical network ports 440.

The other functions 415 executed by the NIC operating system 400 of some embodiments can include various other operations, including execution of lightweight ML models. In other embodiments, the ML model is executed by one of the additional ASICs 445, but the NIC OS 400 evaluates the confidence measure output by the ML model and determines whether to return the output of the lightweight model or pass the input to the full ML model on the computer system to which the smart NIC attaches.

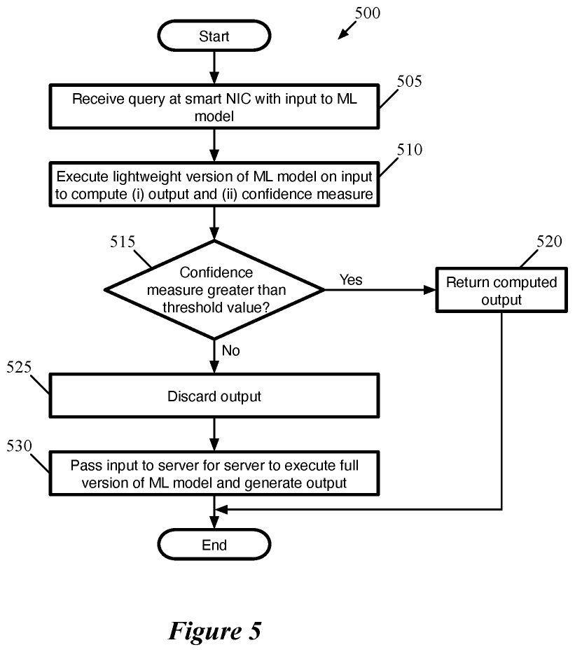

FIG. 5 conceptually illustrates a process 500 of some embodiments for applying an ML model to an input received at a smart NIC (e.g., the smart NIC 105). The process 500, in some embodiments, is performed at least in part by the smart NIC operating system executing on the smart NIC's CPU. In some embodiments, the smart NIC performs the process 500 for each ML model input received at the smart NIC.

As shown, the process 500 begins by receiving (at 505), at a smart NIC, a query with an input for an ML model implemented by an ML server implemented on the computer to which the smart NIC is attached and for which the smart NIC acts as an interface. Though not shown in the figure, if the host computer implements multiple different ML models, the smart NIC also identifies which model the input is for. In some embodiments, the input is received as the payload to one or more data messages received through a physical port of the smart NIC (e.g., if the input is an image or audio snippet that cannot be sent as a single data message). In this case, the smart NIC assembles the input from the data message payloads. In addition, the smart NIC identifies the received payload(s) as storing an input to the ML model based on the header values of the data messages (e.g., the destination network address and/or transport layer port values, application layer header values, etc.).

Upon receiving the input, the process executes (at 510) the lightweight version of the ML model that is stored on the smart NIC using the received input as the input to the model. The lightweight version of the model outputs both (i) an output and (ii) a confidence measure. As described below, the structure of the lightweight version of the model depends on the type of ML model executed by the ML server (e.g., a convolutional or other type of neural network, a random forest, a boosting model, etc.).

In different embodiments, the ML model may categorize each input into one of a set of categories (e.g., which of a predefined set of object types is present in an image), determine whether the input matches a specific category (e.g., does the audio input match a particular person's voice), detect whether a particular event has occurred (e.g., is an anomaly identified in a network), or perform a different task. The output specifies the result of the model (e.g., identification of an object, identification of an anomaly type, specification as to whether a particular voice is present in audio or object is present in an image or video, etc.).

The confidence measure, meanwhile, indicates the likelihood that the lightweight model is providing the correct answer. For instance, a model that classifies an input into one of a set of categories typically generates a probability distribution across the categories (i.e., a probability for each category that the input belongs to that category, with the probabilities adding up to 1). The output provided by the model is generally the category with the highest probability, but this highest probability may not actually be close to 1 in many cases. For instance, a model could output a 45% probability for a first category, a 30% probability for a second category, and a 25% probability for a third category (such that the output is the first category). In some such embodiments, the confidence measure is simply the probability assigned to the category identified as the output (i.e., the category with the highest probability). Other models identify whether a particular event has occurred (i.e., providing a yes/no answer based on two probabilities), and the confidence measure is the probability assigned to the answer. Still other models that provide other types of outputs may use as the confidence measure a probability used to inform the output or calculate the confidence measure separately, in different embodiments.

The process 500 then determines (at 515) whether the confidence measure is greater than a threshold value. The threshold value, in some embodiments, is set by the designer of the ML model, and may vary depending on the requirements of the systems using the ML server. For instance, systems that require high accuracy may use a higher threshold than systems for which occasional incorrect outputs are okay. In addition, some embodiments set the threshold based on experimentation with the model to identify the threshold above which the lightweight version of the model will give the correct answer a suitably high percentage of the time.

When the confidence measure is above the threshold (e.g., 0.9), the process 500 returns (at 520) the output without any need for processing by the full version of the ML model. As such, the input does not need to be passed to the ML server (i.e., to the computer on which the ML server is implemented). Instead, the smart NIC sends the output (e.g., as a data message or series of data messages) to the source of the input, and ends. As indicated above, when the lightweight version of the ML model on the smart NIC can be used, this is significantly faster than passing the input to the (slower) ML server.

On the other hand, when the confidence measure is below the threshold, the process 500 discards (at 525) its generated output and passes (at 530) the input to the ML server for the server to execute the full version of the ML model and generate its own output. The process 500 then ends. After the ML server generates the output for the received input, the ML server returns that output to the source of the input (e.g., as a data message or series of data messages). In some embodiments, these data messages are sent to the source via the smart NIC. The output generated by the full version of the ML model is more likely to provide a correct answer to the query represented by the input, but with a greater latency.

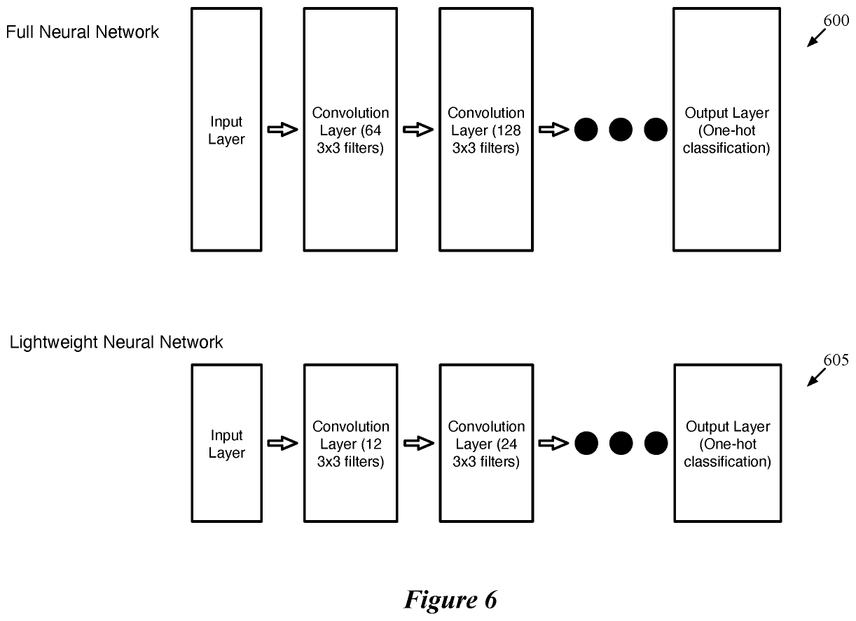

The relation of the lightweight version to the full version of the ML model depends on the type of ML model, in some embodiments. FIGS. 6-8 conceptually illustrate examples of full and lightweight versions of different types of ML models, though it should be understood that various other types of models are also possible in different embodiments.

FIG. 6 conceptually illustrates a full version 600 and a lightweight version 605 of a convolutional neural network of some embodiments. In this example, the full neural network 600 and the lightweight neural network 605 have the same number of layers, but the lightweight neural network uses smaller layers. For instance, the first convolutional layer of the full network 600 has 64 3×3 filters whereas the first convolutional layer of the lightweight network has only 12 3×3 filters. Both neural networks 600 and 605 output a one-hot classification (i.e., classifying an input into one of several possible categories), though neural networks could also provide multiple output categories for inputs that can have any number of items present in different categories. In some embodiments, the two neural networks are trained separately (i.e., the lightweight network is not generated based on the trained full version) but using the same training dataset. In other examples, the lightweight version of the neural network could have fewer layers (or fewer and smaller layers) than the full version of the network. In addition, some embodiments ensure that the lightweight version is sparser than the full version (i.e., a greater percentage of the weights of the lightweight version are pushed to zero in training than in the full version) to make for simpler computations.

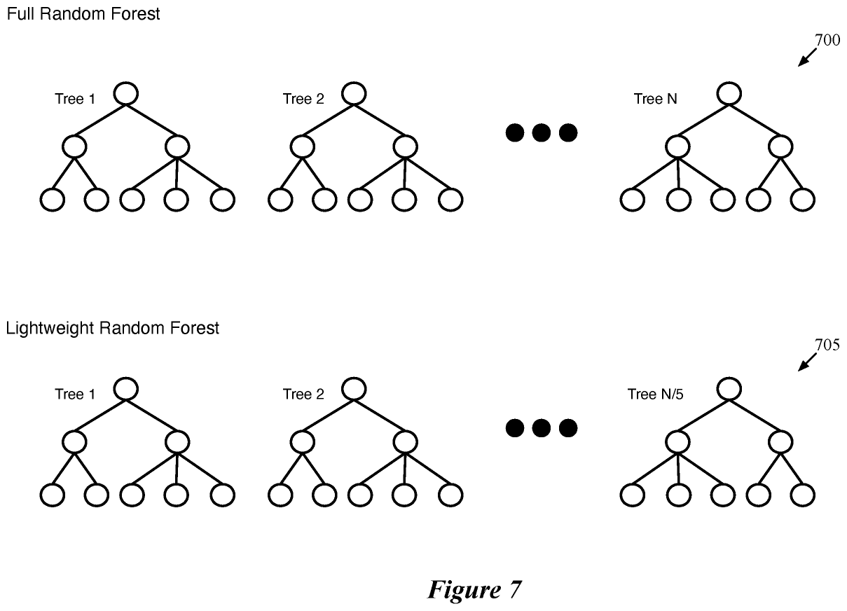

FIG. 7 conceptually illustrates a full version 700 and a lightweight version 705 of a random forest (RF) model of some embodiments. An RF model uses numerous decision trees for tasks such as classification or regression by averaging the results from the trees. In this example, the full version 700 of the RF model has N trees, while the lightweight version 705 uses a subset (N/5) of these trees. Other embodiments may use a different percentage of the trees of the full model for the lightweight version. Some embodiments train the full version of the RF model, then prune this by selecting the subset of trees to use in the lightweight version. These trees may be selected randomly, by ordering the trees and selecting every ith tree, etc.

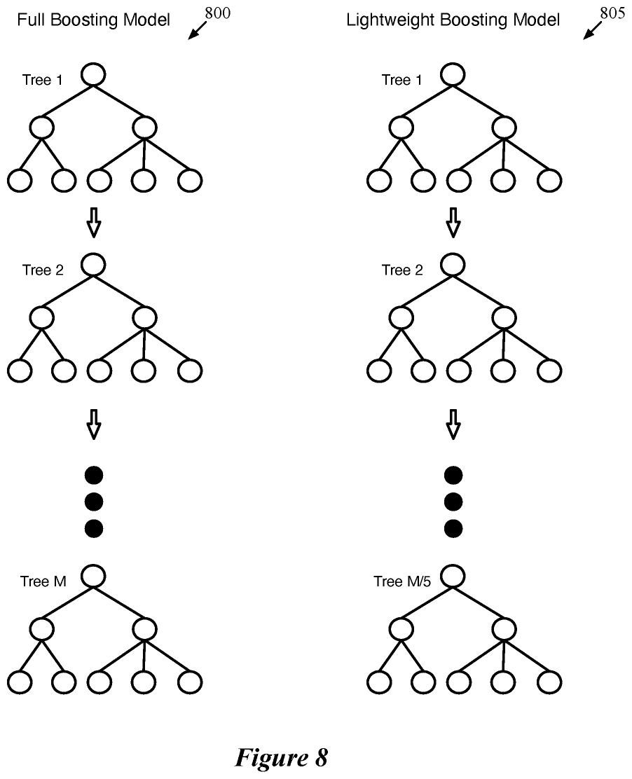

FIG. 8 conceptually illustrates a full version 800 and a lightweight version 805 of a boosting model of some embodiments. Some boosting models, as shown, use a series of decision trees to perform a task (e.g., classification). In this example, the full version 800 of the boosting model has M trees in succession, while the lightweight version 805 uses a subset (M/5) of these trees. Other embodiments may use a different percentage of the trees of the full boosting model for the lightweight version. Some embodiments train the full version of the boosting model, then prune this by selecting the subset of trees to use in the lightweight version. These trees may be selected randomly, by ordering the trees and selecting every ith tree, etc.

In the examples shown in FIGS. 7 and 8, the lightweight version of the RF or boosting model is generated by using a subset of the decision trees of the trained full version of the model. In some embodiments, rather than generating the lightweight version directly from the full version of the model, the lightweight version of the model is trained separately. For instance, for either the RF or boosting models, a lightweight version could be trained by using a smaller number of decision trees and/or shorter decision trees (i.e., trees with less depth).

Furthermore, in some embodiments the lightweight model and the full model need not even be the same type of ML model, so long as the two models are trained to perform the same task and the lightweight model generates both an output and a confidence measure. For instance, the ML server could use a neural network to provide a high-confidence output while the smart NIC uses a simple RF or boosting model to generate an initial output and confidence measure. Any other combination of lightweight and full ML models is possible as well.

A specific example of an ML model for which a lightweight version can be generated and used is an anomaly detection model described in “RADE: Resource-Efficient Supervised Anomaly Detection Using Decision Tree-Based Ensemble Methods”, by Vargaftik, et al., Machine Learning 110, 2835-2866 (2021), which is incorporated herein by reference. This anomaly detection model uses a coarse-grained decision tree-based ensemble method (DTEM) to classify a majority of queries while passing some queries onto one of several “expert” models. Another specific example can be found in “Efficient Multiclass Classification with Duet”, by Vargaftik and Ben-Itzhak, EuroMLSys '22, pp. 10-19 (April 2022).

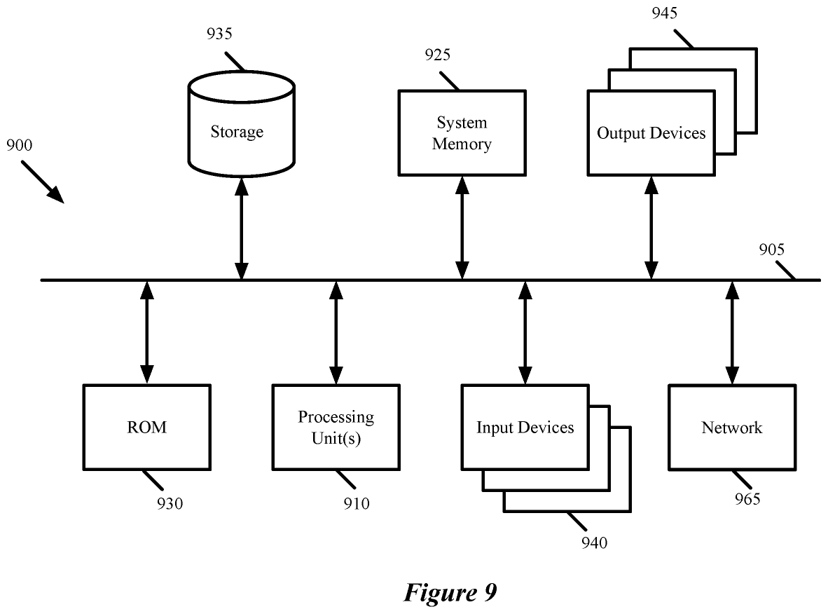

FIG. 9 conceptually illustrates an electronic system 900 with which some embodiments of the invention are implemented. The electronic system 900 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 900 includes a bus 905, processing unit(s) 910, a system memory 925, a read-only memory 930, a permanent storage device 935, input devices 940, and output devices 945.

The bus 905 collectively represents all system, peripheral, and chipset buses that communicatively connect the numerous internal devices of the electronic system 900. For instance, the bus 905 communicatively connects the processing unit(s) 910 with the read-only memory 930, the system memory 925, and the permanent storage device 935.

From these various memory units, the processing unit(s) 910 retrieve instructions to execute and data to process in order to execute the processes of the invention. The processing unit(s) may be a single processor or a multi-core processor in different embodiments.

The read-only-memory (ROM) 930 stores static data and instructions that are needed by the processing unit(s) 910 and other modules of the electronic system. The permanent storage device 935, on the other hand, is a read-and-write memory device. This device is a non-volatile memory unit that stores instructions and data even when the electronic system 900 is off. Some embodiments of the invention use a mass-storage device (such as a magnetic or optical disk and its corresponding disk drive) as the permanent storage device 935.

Other embodiments use a removable storage device (such as a floppy disk, flash drive, etc.) as the permanent storage device. Like the permanent storage device 935, the system memory 925 is a read-and-write memory device. However, unlike storage device 935, the system memory is a volatile read-and-write memory, such a random-access memory. The system memory stores some of the instructions and data that the processor needs at runtime. In some embodiments, the invention's processes are stored in the system memory 925, the permanent storage device 935, and/or the read-only memory 930. From these various memory units, the processing unit(s) 910 retrieve instructions to execute and data to process in order to execute the processes of some embodiments.

The bus 905 also connects to the input and output devices 940 and 945. The input devices enable the user to communicate information and select commands to the electronic system. The input devices 940 include alphanumeric keyboards and pointing devices (also called “cursor control devices”). The output devices 945 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 9, bus 905 also couples electronic system 900 to a network 965 through a network adapter (not shown). In this manner, the computer can be a part of a network of computers (such as a local area network (“LAN”), a wide area network (“WAN”), or an Intranet, or a network of networks, such as the Internet. Any or all components of electronic system 900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIG. 5) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for using a machine learning (ML) model to respond to a query, the method comprising:
at a smart NIC of a computer:
receiving a query comprising an input;
applying a first ML model to the input to generate an output and a confidence measure for the output; and
when the confidence measure for the output is below a threshold, discarding the output and providing the query to the computer for the computer to apply a second ML model to the input.

2. The method of claim 1, wherein:
the first ML model is a first neural network; and
the second ML model is a second neural network trained with a same dataset as the first neural network.

3. The method of claim 2, wherein the first neural network has fewer nodes than the second neural network.

4. The method of claim 2, wherein:
the first neural network comprises a first set of weight parameters;
the second neural network comprises a second set of weight parameters; and
a greater percentage of weight parameters are equal to zero in the first set of weight parameters than in the second set of weight parameters.

5. The method of claim 1, wherein:
the first and second ML models are random forest (RF) models for classifying inputs;
the second RF model comprises a particular number of decision trees; and
the first RF model comprises only a subset of the decision trees of the second version.

6. The method of claim 1, wherein:
the first and second ML models are boosting models for classifying inputs;
the second boosting model comprises a particular number of decision trees; and
the first boosting model comprises only a subset of the decision trees of the second version.

7. The method of claim 1, wherein the first ML model is a first type of model and the second ML model is a second, different type of model.

8. The method of claim 1, wherein the output of each of the first and second ML models comprises a classification of the input into one category of a plurality of categories.

9. The method of claim 8, wherein the confidence measure comprises a probability that the classification by the first ML model identifies a correct category for the input.

10. The method of claim 1, wherein the output of each of the first and second ML models comprises a classification of the input into one or more categories of a plurality of categories.

11. The method of claim 1, wherein when the confidence measure for the output is above the threshold, the smart NIC provides the output generated by the first ML model as a response to the query without providing the input to the server.

12. The method of claim 11, wherein the smart NIC providing the response to the query without providing the input to the computer enables the response to the query to be sent faster than when the smart NIC provides the query to the computer.

13. A non-transitory machine-readable medium storing a program for execution by at least one processing unit of a smart network interface card (NIC) of a computer, the program for using a machine learning (ML) model to respond to a query, the program comprising sets of instructions for:
receiving a query comprising an input;
applying a first ML model to the input to generate an output and a confidence measure for the output; and
when the confidence measure for the output is below a threshold, discarding the output and providing the query to the computer for the computer to apply a second ML model to the input.

14. The non-transitory machine-readable medium of claim 13, wherein:
the first ML model is a first neural network;
the second ML model is a second neural network trained with a same dataset as the first neural network; and
the first neural network has fewer nodes than the second neural network.

15. The non-transitory machine-readable medium of claim 13, wherein:
the first ML model is a first neural network comprising a first set of weight parameters;
the second ML model is a second neural network, trained with a same dataset as the first neural network, comprising a second set of weight parameters; and
a greater percentage of weight parameters are equal to zero in the first set of weight parameters than in the second set of weight parameters.

16. The non-transitory machine-readable medium of claim 13, wherein:
the first and second ML models are random forest (RF) models for classifying inputs;
the second RF model comprises a particular number of decision trees; and
the first RF model comprises only a subset of the decision trees of the second version.

17. The non-transitory machine-readable medium of claim 13, wherein:
the first and second ML models are boosting models for classifying inputs;
the second boosting model comprises a particular number of decision trees; and
the first boosting model comprises only a subset of the decision trees of the second version.

18. The non-transitory machine-readable medium of claim 13, wherein:
the output of each of the first and second ML models comprises a classification of the input into one category of a plurality of categories; and
the confidence measure comprises a probability that the classification by the first ML model identifies a correct category for the input.

19. The non-transitory machine-readable medium of claim 13, wherein the program further comprises a set of instructions for providing the output generated by the first ML model as a response to the query without providing the input to the server when the confidence measure for the output is above the threshold.

20. The non-transitory machine-readable medium of claim 13, wherein the program is executed by a central processing unit of the smart NIC.

21. The non-transitory machine-readable medium of claim 20, wherein the set of instructions for applying the first ML model to the input comprises a set of instructions for providing the input to a separate processing unit of the smart NIC that executes the lightweight ML model and receiving the output and the confidence measure from the separate processing unit.
